(19) United States
(12) Patent Application Publication
(10) Pub. No.: US 2009/0190633 A1
(43) Pub. Date: Jul. 30, 2009

(54) INTERFERENCE MITIGATION OF SIGNALS WITHIN THE SAME FREQUENCY SPECTRUM

(76) Inventor: Francis J. Smith, Park City, UT (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/019,595

(22) Filed: Jan. 24, 2008

(51) Int. Cl. H04B 15/02

(52) U.S. Cl. 375/148; 375/346

(57) ABSTRACT

Various apparatuses and methods are described herein to reduce the interference in receivers in bands were more than one signal is present. The embodiments also describe a receiver that is capable of providing interference mitigation for both WiFi and Bluetooth and wireless telephony standards in the same receiver. The receiver is capable of receiving WiFi and Bluetooth at the same time in the same ISM channel and removing the mutual interference. The embodiments also include the capability to remove other extraneous interfering signals from WiFi and Bluetooth in the ISM band to include cordless phones and energy from microwave ovens. The interfering signals are isolated and subtracted from the signals of interest. It also describes apparatuses and methods for pre-distorting signals to provide for the operation of amplifiers in the non-linear region where the PAE is greatest.

### BACKGROUND

1. Field

Embodiments of the invention relate to the field of radio receivers and nonlinear transmitters; and more specifically, to the interference compensated radio receivers that demodulate multiple modulations and bandwidth signals and provide interference compensation.

2. Background

In the field of radio receives and nonlinear transmitters there are Mutual Interference problems with Personal Area Networks (PAN), such as WiFi® and Bluetooth™. Mutual interference is the interference experienced by a user from signals generated by that user, such as Bluetooth, WiFi, or the like on the same personal computer (PC). The term WiFi is used to describe 802.11a/b/g in the Industrial, Scientific, Medical (ISM) band and the 5 GHz band. Bluetooth is an industrial specification for wireless PANs. Bluetooth provides a way to connect and exchange information between devices such as mobile phones, laptops, PCs, printers, digital cameras, and video game consoles over a secure, globally unlicensed short-range radio frequency. The Bluetooth specifications are developed and licensed by the Bluetooth Special Interest Group. The ISM band described herein is between 2.4 and 2.485 MHz.

FIG. 1 depicts the Mutual Interference problem with WiFi and Bluetooth™ (BT) and the interference that can be experienced by other signals in the ISM band. FIG. 1 also shows the interference that can be experienced from other sources, such as cordless phones, microwave ovens, etc.

As an example, this is seen in some wireless telephony applications in boundary areas between different cellular systems, when narrowband signals like Advanced Mobile Phone System (AMPS) are used in one area at the same frequency as that used by Code Division Multiple Access (CDMA) in the adjacent area. AMPS is the analog mobile phone system standard and is an analog frequency modulated (FM) cellular telephony. In this situation, a low power wideband signal experiences interference from a narrowband high power signal.

Wireless Wide Area Networks (Wireless WAN), such as WiFi or 802.11a/b/g, and Wireless Personal Area Networks (Wireless PAN) are often employed together as shown in FIG. 1. In the following discussions, these will be referred to as WAN and PAN, WiFi and BT, and 802.11b/g and BT. WAN includes 802.11a/b/g and related wireless networks and PAN includes Bluetooth and related networks.

When 802.11b/g and Bluetooth are employed at the same time, there is a high probability of mutual interference since both wireless networks utilize the same RF channel, the ISM band as shown in FIG. 1. This is an unlicensed band and both standards are unregulated in this band. The ISM band also includes other applications such as microwave ovens and cordless phones. It is reasonable to assume that additional applications will use the ISM band and the interference among the numerous applications will cause increased interference. The WAN and PAN in the ISM band do conform to the IEEE standards which provides some assistance in mutual interference mitigation, but it is not a complete solution. The 802.11b and g standards are broadband signals (20 to 22 MHz) and the Bluetooth is a narrowband signal (less than 1 MHz). The 802.11b and g are located in the ISM band along with the Bluetooth. The primary concern, but not the only concern, for mutual jamming is in the personal computer (PC) which is employing both standards.

In addition, microwave ovens operate in the ISM band and are high power devices and can also interfere with wireless communications systems. Also, some cordless telephones operate in the ISM band, around 2.4 GHz and they are spread spectrum (DSSS), and they can also interfere with the 802.11b/g and the Bluetooth applications.

In the situation where Bluetooth and 802.11b/g are used simultaneously on the same PC or laptop, the transmission from the PC 802.11b/g may jam the Bluetooth reception and the Bluetooth transmission may jam the 802.11b/g reception. Some conventional system architectures have been proposed and developed where the baseband processors, Media Access Control (MAC), are tied together and coordinated such that the simultaneous transmission of the 802.11b/g and Bluetooth signals is precluded. Another scheme involves adaptive hopping of the Bluetooth signal such that the sub-band of the ISM band being utilized by the 802.11b/g signal is avoided by the Bluetooth hopping signal when the 802.11b/g is active. However, this scheme requires changes to the standards and the baseband MAC processors.

### BRIEF DESCRIPTION OF THE DRAWINGS

The invention may best be understood by referring to the following description and accompanying drawings that are used to illustrate embodiments of the invention. In the drawings:

FIG. 1 is a drawing showing the interference problems experienced by WiFi and Bluetooth in the ISM band.

FIG. 2 illustrates one embodiment of the 802.11a/b/g and Bluetooth Receiver with Mutual interference mitigation of signals in the ISM band (802.11b/g).

FIG. 3 illustrates one embodiment of a technique for sub-sample phase shifting.

FIG. 4 illustrates an alternate embodiment of an apparatus that provides receiver interference mitigation when the interference is from third party interference and or extraneous interfering signal incident on the PC.

FIG. 5 illustrates one embodiment of the top level architecture for the multi-mode telephony receiver with interference mitigation.

FIG. 6 illustrates one embodiment of a subset of FIG. 5 which provides an architecture where cells used for wireless telephony are reused for the WiFi and BT providing for a highly integrated Cellular and W-Fi/BT capable phone which can switch between modes such as cellular telephone to voice over IP on WiFi within the same physic layer chip.

FIG. 7 illustrates one embodiment of the non-linear transmitter that provides the capability to operate high power transmission amplifiers in the non-linear range where the power added efficiency (PAE) is greatest.

FIG. 8 illustrates a top level of one embodiment of the transmitter and receiver architecture for a WiFi BT and wireless Telephony where any of the wireless standards can be selected and interference mitigation is provided.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The embodiments described herein provides the capability to implement a multi-standard Wireless Local Area Network Receiver with 802.11a/b/g and Bluetooth while providing for interference mitigation for the mutual interference of 802.11b/g and Bluetooth which are in the same frequency band. It also provides the capability to implement a combined cellular telephony receiver with the WiFi and BT capability while providing interference mitigation for all standards. In one embodiment, multiple standards are available simultaneously by duplicating cells. In another embodiment; one standard is selectable at a time providing a savings in power and circuit complexity.

The embodiments described herein relate to interference compensated radio receivers that demodulate multiple modulations and bandwidth signals and provide interference compensation. The embodiments may include mutual interference mitigation when two radio signals use the same spectrum. The embodiments described herein may be applicable to the 802.11b/g and Bluetooth Mutual Interference Problem in the ISM band, but may also be applicable to other frequency bands in that the embodiments of the present invention are carrier frequency independent. In one embodiment, all functions are performed at the physical layer without special interfaces to base band MAC processors.

It should be noted that while the 802.11b/g and Bluetooth and cordless phones and microwave ovens used in the ISM band are used to describe this invention, it is not the intention of this description to limit the application to the ISM band. Cordless phone, as used herein, refers to a telephone whose base of the phone is a fixed point and the handset is connected to the base by a radio signal. The cordless phones, as described herein, may be, for example, CDMA DSSS phones in the ISM band. As described above in the example, the problem where there multiple signals using the same bands in some wireless telephony applications in boundary areas between different cellular systems, when narrowband signals like AMPS) are used in one area at the same frequency as that used by CDMA in the adjacent area. The embodiments described herein are not frequency dependent and is applicable to a wide range of problems where there are multiple signals using the same bands. The embodiments described herein are applicable to problems of this nature also.

The embodiments herein implement interference mitigation techniques are that may significantly reduce the impact of the interference on the 802.11b/g and Bluetooth. This interference mitigation techniques described herein cover both BT that is operated on a PC with 802.11b/g and BT interfering signals (from other users and applications) that are not associated with the PC with the 802.11b/g and BT. In particular, there are three different techniques to deal with three different interference problems experienced by 802.11b/g and Bluetooth in the ISM band. It is also applicable to similar problems in other bands because the techniques are frequency and modulation independent. The interference mitigation techniques use three different approaches that can be implemented separately or together. In one embodiment, all functions are performed at the physical layer without special interfaces to base band MAC processors.

There are three interference mitigation architectures described herein as well as the non-linear transmitter that provides for the transmission of non-constant envelope signals like 802.11a/g with an amplifier operated in the nonlinear region where the power conversion efficiency is greatest. There are three receiver interference mitigation architectures. The first is for BT and 802/11b/g on the same PC platform. The second is for the BT interference coming from applications not on the PC platform in question. The third is for any extraneous signals in the ISM band that are interfering with the 802//1b/g and or the BT.

### Overview

802.11b/g on the Same PC with the BT Applications

The first technique addresses the problem of 802.11b/g and BT on the same PC platform where in the 802.11b/g transmission from the PC jams the BT reception in the PC and the BT transmission jams the 802.11b/g reception in the PC. In this embodiment, the transmitted signals from the BT and the 802.11b/g are present in the PC (since they are transmitted from the PC) and they are used to cancel out the interference in the receive band. In this embodiment, the BT and the 802.11b/g are simultaneously received on the same channel and the 802.11b/g is cancelled out the BT received signal and the BT is cancelled out of the 802.11b/g signal. This is the dominant interference scenario.

The 802.11b is a direct sequence spread spectrum (DCSS) system and the Bluetooth is a frequency hopped (FH) system. The ISM band is approximately 85 MHz wide and the 802.11b/g systems divide the band into three sub-bands of 20 to 22 MHz. The Bluetooth signal is hopped over 79 frequencies at 1600 times per second. When the PC is receiving an 802.11b or g signal, a Bluetooth transmission from the PC can jam the 802.11b/g receive signal. When the PC is receiving a Bluetooth signal, the 802.11b/g can jam the Bluetooth reception. The Bluetooth signal is short range signal (on the order of a few meters) and the 802.11b/g signals operate over a range of over 100 meters. The Bluetooth signal is normally not strong enough to be a serious problem beyond a few meters from the PC. However, it is possible for another Bluetooth, (one not on the primary device with 802.11b/g and Bluetooth), to induce interference on the system in questions. The interference scenario occurs when the “other” Bluetooth is close enough to the platform in questions to jam the reception of the 802.11b/g.

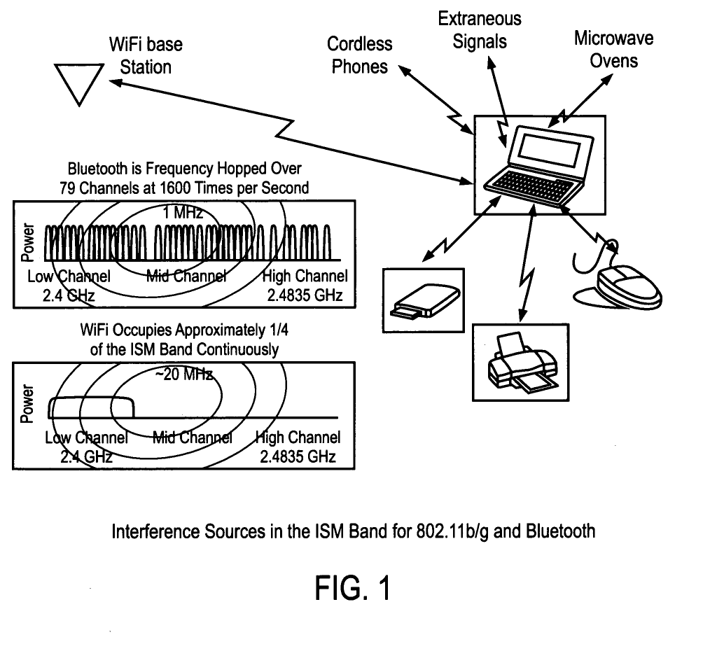

There are a few jamming scenarios that are plausible. The first being the self jamming discussed above. As shown in FIG. 1, the PC peripheral devices connected to the PC via the Bluetooth system can potentially be jammed by the 802.11b/g transmission from the PC when the PC is transmitting a Bluetooth signal at the same time it is transmitting an 802.11b/g signal. In the PC, the Bluetooth and 802.11b/g transmissions result in mutual interference in the receive signals. As described below, the embodiments described herein mitigate these jamming scenarios while requiring no changes to existing standards or existing baseband processors for the 802.11b/g or the Bluetooth Media Access Control (MAC) layers.

In the situation where Bluetooth and 802.11b/g are used simultaneously on the same PC or laptop, the transmission from the PC 802.11b/g may jam the Bluetooth reception and the Bluetooth transmission may jam the 802.11b/g reception. The embodiments described herein take advantage of the fact that the jamming signals from the 802.11b/g and the Bluetooth on the PC are available. These signals are used to cancel the interference in the received 802.11b/g and the Bluetooth.

However, unlike the conventional system architectures described above that tie together and coordinate the baseband processor and MAC, and that involve adaptive hopping of the Bluetooth signal, the embodiments described herein include an apparatus for canceling the mutual 802.11b/g and Bluetooth interference in the PC and an apparatus for buffering and delaying the Bluetooth transmission such that the PC does not transmit the Bluetooth and 802.11b/g signals simultaneously. This precludes jamming of the reception of the Bluetooth signal by the peripheral devices connected to the PC via the Bluetooth system. The BT receivers in the peripheral devices have an inherent 20:1 advantage over the 802.11b/g just due to the narrowband filtering of the BT signal. The advantage may be, for example, 10×log(20) or 13 dB. This scheme, unlike the conventional system architectures, does not require changes to the standards and the baseband MAC processors.

BT Interfering Signal that are not on the PC in Question

In the second technique, involves the cancellation of BT signals in the 802.11b/g pass band that are not transmitted from the PC. In this case, a copy of the interfering signal is not available. This can be from peripheral devices talking to the PC or from other BT signals that are received by the PC in sufficient strength to impact the 802.11b/g and BT reception. In this technique, the location of the interference signal is isolated by an fast Fourier transform (FFT) and the locations, timing and frequency of the BT hopped signals is rapidly determined and the interfering signals are isolated and used to cancel the interference within the desired signal. In the case of BT on 802.11b/g, the BT is a narrowband (less than 1 MHz) signal and the 802.11b/g are 20 to 22 MHz wide. When the BT signal is used to cancel the interference, the energy lost by the 802.11b/g is only 1/20 or about 0.2 dB, for example. In one embodiment, programmable notch filters are used. This is a vast improvement over the signal to interference ration (SIR) experience prior to cancellation which can be as low a 0 dB, for example.

In this embodiment, the Bluetooth signal is received and used to cancel the Bluetooth interference on the 802.11b/g. This technique takes advantage of the fact that the signal to interference ratio between the Bluetooth and the 802.11b/g can be near 0 dB. The Bluetooth signal has its power concentrated in less than 1 MHz and the 802.11b/g signal has its energy contained in 20 to 22 MHz. This technique may narrowband filter the Bluetooth signal (providing a 13 dB signal-to-interference (SIR) advantage over 802.11b/g) and then invert it and cancel it out of the 802.11b/g signal. This may reduce the signal strength of the 802.11b/g by 1/20 or about 0.2 dB, for example. This may have little effect on the signal-to-noise ratio (SNR), but will significantly reduce the SIR. A fast search algorithm may be used to locate the interfering energy and isolate a copy of the interfering signal. The isolated copy may then be used cancel the in-band interfering signal. This technique is applicable to Bluetooth interference sources that are both collocated with the 802.11b/g and independent of the 802.11b/g on the PC in question. This technique may also be used to suppress other narrowband interfering signal in the band of interest of the wider band 802.11b/g signals.

Extraneous Signals in the ISM Band Interfering with 802.11b/g and Bluetooth

The third technique involves the mitigation of interference by extraneous signals other than Bluetooth on the 802.11b/g. These types of extraneous signals include any non-cooperative signals of any type that are present in the unlicensed ISM band. There are two wide classes of signals that fall into this grouping. These are direct sequence spread spectrum signals and other energy signals. In the case of the DSSS signals such as cordless phones are of primary interest. Other energy signals involve any signals above the signal level floor of the 802.11g/b which include microwave ovens and other unknown signals. In cordless phones, the spreading sequences are not difficult to determine and the signals can be de-spread, narrowband filtered and re-spread and then used as an interference cancellation signal. The cancellation signal is any signal that is used to cancel the interference in another signal. In the case of the other energy signals, the other energy signals that are above the signal floor of the 802.11g/b in 1 MHz bins (pass bands) (other bin band sizes also work depending on the application), are isolated with an FFT and programmable pass band filters are used to isolate the high power interfering signals, and these signals are then used to cancel the interference. In one embodiment, programmable notch filters are used. The reduction of the signal of interest (SOI) signal strength and thus the SNR will be the ratio of the cancellation signal to that of the SOI. In the case of a 1 MHz BT signal, the signal strength reduction of the 802.11b/g is 1/20 or 0.2 dB.

In one embodiment, the 802.11b/g and BT receiver with mutual interference mitigation is integrated with a wireless telephony receiver to provide a multi-mode multi purpose PDA with telephony and WiFi capability in the same device.

Non-Linear Transmitter

The embodiments described herein may include a non-linear transmitter that pre-distorts the 802.11/a/b/g signal prior to the input to the high power amplifier. The transmitter pre-distorts the signal to pre-compensate for the AM/AM and AM/PM distortion of the amplifier chain so that the signal at the output of the high power amplifier is nearly distortion free. Since the non-linear characteristics of the amplifier chain can be expected to change over time and temperature, the embodiments may also include an apparatus for adjusting the pre-distortion algorithms over time and temperature variation.

Another problem experienced in power amplifiers is signal clipping. When the signal is clipped by the transmitter, higher frequency components are generated, and the out-of-band emissions grow. The embodiments described herein may also include an apparatus to preclude amplifier clipping and thus controls the out of band emissions of the transmitter.

The functions of the embodiments described herein may be performed at the physical layer without special interfaces to base band MAC processors. The physical layer is the portion of the radio that does not include the baseband MAC layer. The physical layer includes the functions from the radio frequency (RF) input to the zero intermediate frequency (IF) I and Q digital representation of the signal. The physical layer is modulation independent in that is does not determine the final decision values, but simply decomposes the RF signal either coherently or non-coherently into the I and Q complex signal components and provides the signals in analog or digital form to the base band processor.

### Mutual Interference Mitigation

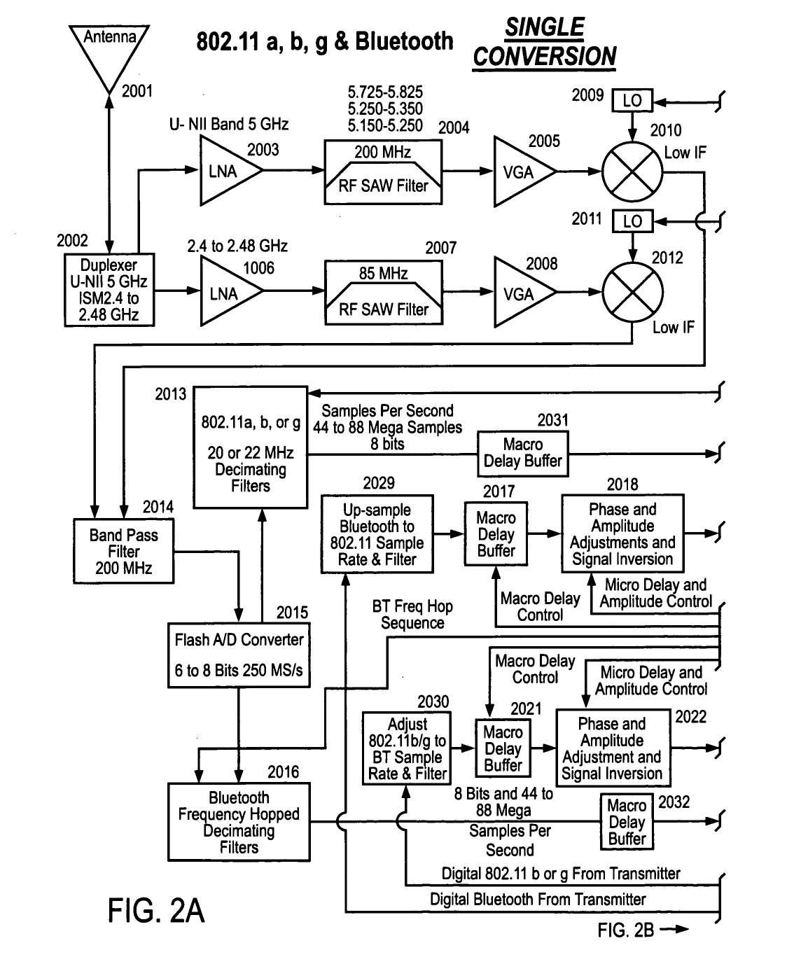

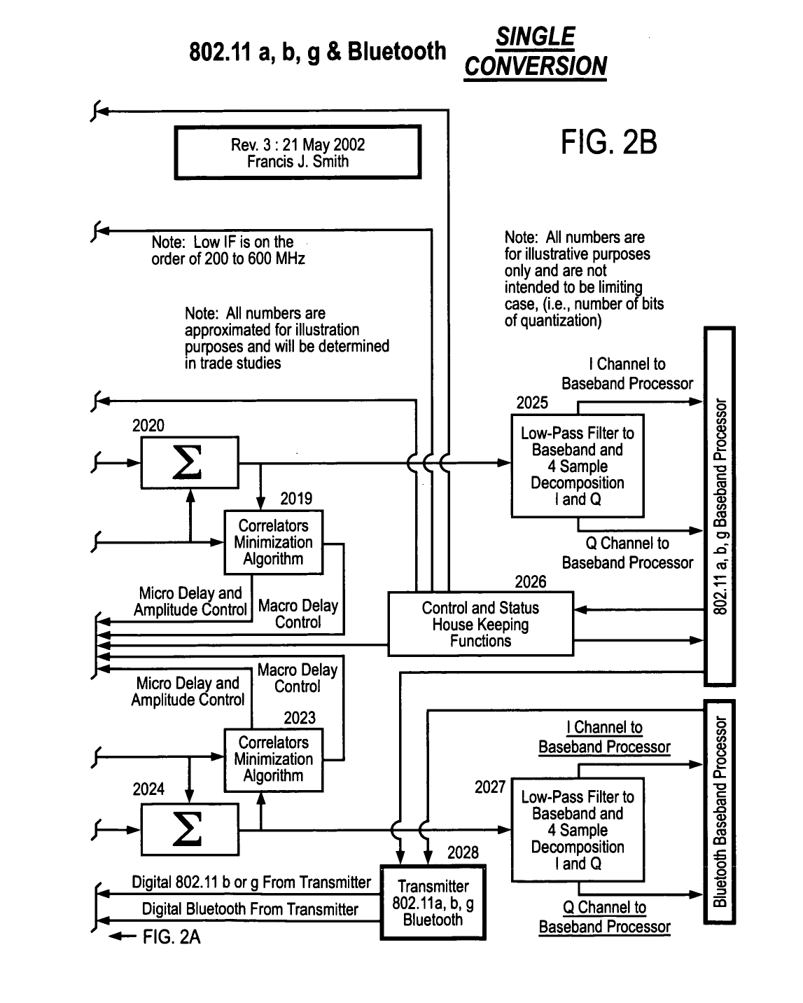

FIG. 2 illustrates one embodiment of the 802.11a/b/g and Bluetooth Receiver with Mutual interference mitigation of signals in the ISM band (802.11b/g). This embodiment is for cancellation of mutual interference on the PC by the BT and WiFi with the capability to also receive 802.11a. The RF signal energy is received via the antenna 2001 and fed to the duplexer 2002, which separates the 5 GHz U-NII band from the ISM band at 2.4 to 2.48 GHz. In one embodiment, only one or the other of the two bands is supported. In another embodiment, both bands are supported. In another embodiment, wireless telephony band(s) are also supported. The output of the duplexer 2002 is input to one of two of the Low Noise Amplifiers (LNA) 2003 or 2006 depending on the band in use. In another embodiment, multiple bands are supported and there is a Low-Noise Amplifier (LNA) and Surface Acoustic Wave (SAW) filter for each band.

In one embodiment, SAW filters 2004 and 2007 are used to reject unwanted out of band signals and noise. In another embodiment, the filtering provided by the duplexer is sufficient in conjunction with the digital filters that follow.

In one embodiment, the output of the SAW filters 2004 and 2007 is input to the Variable Gain Amplifier (VGA) 2005 or 2008 where the signal level is set appropriately for the down-converting mixers 2010 and 2012. In one embodiment, a single mixer is used for all bands or multiple bands with the local oscillator (LO) adjusted to achieve the desired frequency conversion. The local oscillators 2009 and 2011 provide the mixing signals for down-converting the two bands to a common and convenient IF. In one embodiment, a single LO is used and PLL is used to generate the desired signals for down-conversion mixing. This frequency typically is some multiple of 1 to 3 times the baseband bandwidth of the down-converted signal. In one embodiment, an IF of 200 to 600 MHz is used. In another embodiment, the IF is zero (direct conversion). In one embodiment, the mixers are image reject mixers. In other embodiments, any desired frequency may be used.

In one embodiment, there are no mixers and the output of the SAW filters or the VGA or the LNA is sent directly to the A/D converters 2015 or to the anti-aliasing filter 2014.

In one embodiment, one of either of the two bands is processed, the 5 GHz U-NII band or the ISM band at 2.4 to 2.48 GHz. In another embodiment, the digital circuits described below are duplicated and both bands are processed simultaneously. In another embodiment, wireless telephony is also added.

In one embodiment, the output of the mixers 1210 or 2012 is input to the anti-aliasing filter 2014. In another embodiment, the filtering provided by the Duplexer, SAW filters and image reject mixers is sufficient to provide anti-aliasing filtering and 2014 is eliminated.

In one embodiment, the output of the mixers 2010 or 2012 or the filter 2014 is input to the flash A/D converter 2015. In another embodiment, the A/D converter may be a Sigma Delta over sampling A/D converter. In one embodiment, the signal is sampled at the RF frequency without down-conversion. In another embodiment, the signal is down-converted to an IF. It should be noted that one of ordinary skill in the art would recognize the frequency of down-conversion does not impact the general application of the embodiments of the present invention.

In one embodiment, the flash A/D (2015) converter samples the entire receive signal passband, for example, at 6 to 8 bits per sample at between 200 and 250 mega samples per second. The sampling rate may vary depending on the receive signal bandwidth. The sampling rate may be set to exceed the Nyquist sampling rate for the signal bandwidth to preclude aliasing. In other embodiments, the other exact sampling rates may be used, since the exact sampling rates is a design implementation detail and does not detract from the general application of the invention.

In one example of one embodiment, the sampling rate is 250 MHz so the quantizing noise bandwidth is 125 MHz. The output of the A/D converter is input to the signal specific decimating filters 2013 or 2016. The decimating filter 2013 is the decimating filter(s) for the 802.11a/b/g and the decimating filter 2016 is the decimating filter for the Bluetooth signal.

802.11a/b/c and Bluetooth Receiver

In one embodiment, the BT and WiFi signals are simultaneously process from the same receive channel and the mutual interference between the two signals is removed in real time. The ISM band at 2.4 GHz and the 5 GHz band are down-converted to a conveniently LOW IF so that the sampling of the passband yields a SNR of 50 to 60 dB, for example. This requires an IF below 1 GHz given the phase noise achievable on the sampling clock. In one embodiment, an IF of 500 to 600 MHz is used. In another embodiment, the IF of 200 to 600 MHz may be used. In one embodiment, which provides for both WiFi and Cellular telephony, the same LO frequency and mixer are used for direct conversion of the telephony signal to zero IF and down-conversion to a convenient IF for the 2.4 GHz band. As an example, when the 1900 MHz PCS signal is converted to Zero IF, the same mixing signal down-converts the ISM band to around 500 MHz. In the mode of WiFi and BT, the digital signal from the A/D converter 2015 in FIG. 2 is input to the two sets of decimating filters, one for the BT and one for the 802.11a/bg. For the BT which is frequency hopped, the decimating filters follow the hopping frequency as does the cancellation of the interference.

Receiver: Processing 802.11b/g Providing BT Interference Mitigation where the BT and WiFi are on the Same PC

In one embodiment, the digital samples from 2015 are filtered in 2013 to either 22 MHz or 20 MHz (for 802.11b and 802.11a,g), for example. The bandwidth reduction is 5:1 so the quantizing signal to noise ratio is improved by a factor of 5 or 7 dB which provides an increase of 1 bit in the sample, yielding between 7 and 9 bits depending on the implementation. The 8 bits is used for the discussion of the example of one embodiment of this invention, however, the embodiments are not limited to 8 bits. The 802.11b standard can use as few as 4 bits, but the Orthogonal Frequency-Division Multiplexing (OFDM), used in 802.11a and g with the higher order modulation, uses an instantaneous dynamic range of up to 50 dB or more than 8 bits. The sample rate at the output of 2013 nominally is two or four times the desired final output rate to the baseband processors (e.g., MAC baseband processors). The reason for this is that the I-Q decomposition is done digitally. The reduction in sample rate is 4:1. Up-sampling may be required if the processing at this stage is done at a lower sample rate.

In one embodiment, the lower processing rate and up-sampling are used to achieve the final sample rate into the MAC baseband processor. In this case, the sample rate out of the decimating filter 2013 is about 44 to 88 mega samples per second for the 802.11 signals. In other embodiments, other sampling rates may be used.

In one embodiment, the output of the flash A/D converter 2015 is simultaneously sent to the decimating filters 2016 and 2013. When 802.11b/g and Bluetooth are processed simultaneously, this will be the case. In one embodiment, the decimating filter 2016 includes one or more programmable decimating filters which are programmed to narrowband filter the frequency hopped Bluetooth signals to approximately 1 MHz. The Bluetooth signal is frequency hopped, for example, at 1600 times per second over 79 frequencies. In one embodiment, the sample rate out of the decimating filter 2016 is set to match the sample rate of the 802.11b/g out of the decimating filter 2013. In other embodiments, other sample rates can be selected, since the sample rate is an implementation detail and does not impact the features of the present embodiment.

In one embodiment, the 802.11b/g and the Bluetooth transmitter(s) block 2028 in FIG. 2, provides a digital copy of the transmitted 802.11b/g and the Bluetooth signal from the transmitter block 2028. In another embodiment, the 802.11b/g and the Bluetooth are analog signals and are down-converted and digitally sampled as required in either the receiver or the transmitter. In one embodiment of the transmitter, as discussed below, a digital copy of the down-converted and sampled transmitter signal after the final amplification is provided to the receiver.

In one embodiment, the transmitter and receiver are implemented on the same integrated circuit. In another embodiment, the functions of the transmitter and receiver are split between multiple integrated circuits. In other embodiments, other configurations may be possible.

The Bluetooth transmit signal is received in the up-sample Bluetooth to 802.11 sample rate and filter 2029 from the transmitter function 2028. In the up-sample and filter block 2029, the Bluetooth signal is up-sampled and frequency converted (in digital form) to match the sample rate of the 802.11b/g and the frequency of the Bluetooth transmit hop frequency. The Bluetooth signal is also filtered so that only Bluetooth signals that fall in-band of the 802.11b/g are processed in the interference cancellation scheme. At this point, there may be a phase and or amplitude difference between the Bluetooth signal received with the 802.11b/g signal and the Bluetooth cancellation signal output from the up-sample and filter block 2029.

A phase difference is effectively a time shift. In one embodiment, the received signal may lead the cancellation signal. In another embodiment, the time shift may be reversed. To accommodate the possible variations in implementations, there may be one or two macro delay buffers 2031 and 2017. The delay buffer 2031 can delay the 802.11b/g signal and the delay buffer 2017 can delay the Bluetooth cancellation signal. These buffers delay signals by an integer number of samples to get the time alignment within one sample period.

In one embodiment, there is a macro delay buffer 2017 and a micro phase adjustment block 2018 for adjustment for the Bluetooth Cancellation signal path. The phase adjustment block 2018 also contains the amplitude adjustment. The block 2018 performs three functions. The block 2018 provides the fine granular adjustments to the phase and amplitude of the Bluetooth cancellation signal and inverts the signals. The output of the block 2018 goes to block 2020 and to block 2019. In the block 2020, the inverted cancellation signal from the block 2018 is added to the 802.11b/g signal from the block 2031 to cancel the interfering Bluetooth signal.

In one embodiment, the output of the 2020 is input to two functions of the blocks 2019 and 2025. The block 2019 receives a copy of the cancellation signal from the block 2018 that was used to cancel the interference. In the block 2019, a complex correlator computes the cross correlation between the output of the block 2020 and the cancellation signal from the block 2018. The complex correlator is a function that computes the cross correlation between two signal in phase and amplitude. The 90 degree phase shifted signal of one signal is cross correlated with the other signal to get the phase correlation and the non-phase shifted version is cross correlated to get the amplitude correlation. The block 2019 sends amplitude and phase control signals to the block 2018 to adjust the phase and amplitude of the cancellation signal to as to drive the cross correlation to a minimum. If the cancellation has been done perfectly, the cross correlation will be zero. There may always be a small residual cross correlation as the algorithm will “dither” around the optimal phase and amplitude adjustment. It should be noted that one of ordinary skill in the art would recognize that the residual error can be made very small as a function of required accuracy and implementation complexity.

In one embodiment, different phase and amplitude offsets may be required at different Bluetooth hopping frequencies. In this case, there can be several frequency bands up to the full 79 frequency hopped 1 MHz band that will have different phase and amplitude corrections to the cancellation signal. In this case, a small on-chip memory may store the offsets as they are determined. This may not take long to determine in that there are only 79 frequencies and the hops are done at 1600 times per second. In one embodiment, these values are continually updated each time the hopped frequency is used.

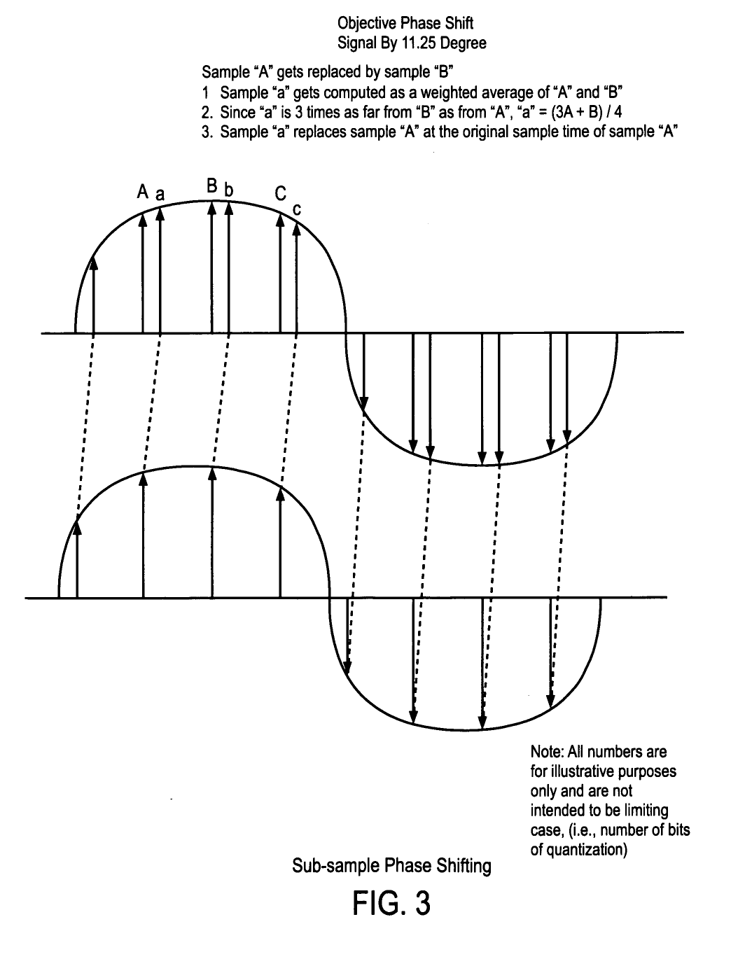

In one embodiment, the Macro delay buffer 2017 provides delays which are an integral multiple of the samples. The micro delay, which provides for sub-sample phase shifts, uses a different technique as shown in FIG. 3. When operating in the digital sample space, it is possible to have an over sampled waveform from Nyquist sampling point of view, but only have a few samples per cycle of the carrier signal (or IF). If full sample delays are used (as in the macro delay buffer), only very large phase shifts are achievable, such as around 75 to 90 degrees. This may not be accurate enough to line up the cancellation signal with the interfering signal. For this reason, the sub-sample phase shift is provided in one embodiment of the invention.

In one embodiment, as shown in FIG. 3, the initial samples are sampled at the times A, B, and C. In one embodiment, intermediate values a, b, and c are computed by linear interpolation and the new values are time mapped into the time slots for A, B, and C. By using this technique, the sub-sample phase shifts can be made arbitrarily small. In another embodiment, a more sophisticated algorithm is used rather than a linear interpolation. In other embodiments, other algorithms may be used.

In one embodiment, after the interference calculation is done in the block 2020, the digital samples are input to the block 2025. In the block 1025, the I and Q signals are separated by a down-sampling apparatus. The digital samples are taken in groups of four samples. The first and the third are averaged to get the I channel and the second and fourth are averaged to get the Q sample. The apparatus of digitally performing the cancellation on a composite signal and then performing the decomposition into the I and Q waveforms eliminates the problems involved with I-Q quadrature and amplitude balance.

In one embodiment, the samples out of the decimating filter 2013 are at four times the desired sample rate out of the block 2025. In another embodiment, the samples out of the decimating filter 2013 are one or two times the desired output sample rate and up-sampling is done prior to outputting the samples to the MAC baseband processor. In other embodiments, other sampling rates may be selected, since the sampling rates are an implementation detail and do not detract from this general application of the invention.

In another embodiment, the digital samples from the block 2020 are multiplied by a digital sine and cosine at the required frequency to down-convert the signals to base band. This can be shown to be functionally same as the down-sampling scheme discussed above.

In one embodiment, the Control and Status and House keeping functions are performed in the block 2026. The block 2026 is the operational interface to the MAC baseband processors for 802.11a, 802.11b, 802.11g and Bluetooth (and telephony if required). The selection of the bands to be received and the signals to be demodulated are provided by the MAC baseband processors and the functional selection if performed by the block 2026 as a slave to the MAC. The block 2026 controls the local oscillators 2009 and 2011. In one embodiment, the elements not in use are powered down to save power and reduce occurrence of cross talk.

In one embodiment, the 5 GHz receive path is utilized to receive 802.11a. The signal is received via LNA 2003, SAW filter 2004, VGA 2005 and mixer 2010. The signal path is sampled at 8 bits (on or about) at 250 Mega Samples per second and input to the 802.11a decimating filter in 2013. The 802.11a signal in not subject to Bluetooth interference and so the functions of blocks 2031 and 2020 are bypassed, and the samples are sent to the block 2025 for digital down-conversion and I-Q decomposition as discussed above for 802.11b/g.

Receiver: Processing Bluetooth and Mitigation of 802.11b/g Interference on BT

In one embodiment, the digital samples from the flash A/D converter 2015 are filtered in the decimating filter 2016 to approximately 1 MHz with a frequency hopped digital programmable filter. The bandwidth reduction is 100:1 so the quantizing signal to noise ratio may be improved by a factor of 20 dB, which provides an increase of 3 bits in the sample, yielding potentially between 10 and 11 bits depending on the implementation. Since more than 8 bits may not be required, 8 bits is used for the discussion of the example of one embodiment of this invention. The sample rate at the output of the flash A/D converter 2015 nominally is two or four times the desired final output rate to the baseband processors (e.g., MAC baseband processors). The reason for this is that the I-Q decomposition is done digitally. The reduction in sample rate is 4:1. In the case of the Bluetooth, the required sample rate is much less than the 802.11b/g, but in one embodiment, the sample rates are kept at the 802.11b/g rates to make signal cancellation easier.

In one embodiment, the 802.11b/g signal from the transmitter is narrowband filtered by a copy of the Bluetooth programmable digital frequency hopped filter. The 802.11b/g signal is then down-sampled to the Bluetooth sample rate. It should be noted that one of ordinary skill in the art would recognize that the implementation details for doing interference cancellation at the Bluetooth rate or the 802.11b/g do not impact the important features or the general applications of this invention.

In one embodiment, the lower processing rate is used and up-sampling used to achieve the final sample rate into the MAC baseband processor. In one embodiment, the sample rate out of 2016 is about 44 to 88 mega samples per second for the 802.11 rate if the Bluetooth is processed at the 802.11 sample rate. If the 802.11 sample rates are used, the Bluetooth signal may be down-sample prior to output to the MAC baseband processor. In other embodiments, other sampling rates may be used.

In one embodiment, the output of the flash A/D converter 2015 is simultaneously sent to the decimating filters 2016 and 2013. When 802.11b/g and Bluetooth are processed simultaneously, this will be the case. In one embodiment, the decimating filter 2016 includes one or more programmable decimating filters which are programmed to narrowband filter the frequency hopped Bluetooth signals to approximately 1 MHz. The Bluetooth signal is frequency hopped at 1600 times per second over 79 frequencies. In one embodiment, the sample rate out of 2016 is set to match the sample rate of the 802.11b/g out of 1013. In other embodiments, other sample rates may be used.

In one embodiment, the 802.11b/g and the Bluetooth transmitter(s) 2028) provide a digital copy of the transmitted 802.11b/g and the Bluetooth signal from the transmitter 2028. In another embodiment, the 802.11b/g and the Bluetooth are analog signals and are down-converted and digitally sampled as required in either the receiver or the transmitter. In one embodiment of the transmitter, as discussed below, a digital copy of the down-converted and sampled transmitted signal after the final amplification is provided to the receiver.

In one embodiment, the transmitter and receiver are implemented on the same integrated circuit. In another embodiment, the functions of the transmitter and receiver are split between multiple integrated circuits. In other embodiments, other configurations may be possible.

The 802.11b/g transmit signal is received in block 2030 from the transmitter function 2028. In the block 2030, the 802.11b/g signal is narrowband filtered, down-sampled and frequency converted as required (in digital form) to match the sample rate of the Bluetooth and the frequency of the Bluetooth transmit hop frequency.

In one embodiment, the 802.11b/g signal is narrowband filtered and down-sampled to match the Bluetooth. In another embodiment, the Bluetooth sample rates are matched to that of the 802.11b/g.

At this point, there may be a phase and or amplitude difference between the 802.11b/g signal received with the Bluetooth signal and the 802.11b/g cancellation signal output from the block 2030.

A phase difference is effectively a time shift. In one embodiment, the received signal may lead the cancellation signal. In another embodiment, the time shift may be reversed. To accommodate the possible variations in implementations, there may be one or two macro delay buffers 2021 and 2032. The delay buffer 2032 can delay the Bluetooth signal and delay buffer 2021 can delay the 802.11b/g cancellation signal. These buffers delay signals by an integer number of samples to get the time alignment within one sample period.

In one embodiment, there is a macro delay buffer 2021 and a micro phase adjustment block 2022 for adjustment for the 802.11b/g cancellation signal path. The phase adjustment block 2022 also contains the amplitude adjustment. Like the block 2018, the block 2022 performs three functions. The block 2022 provides the fine granular adjustments to the phase and amplitude of the 802.11b/g cancellation signal and inverts the signals. The output of block 2022 goes to block 2023 and to block 2024. In the block 2024, the inverted cancellation signal from the block 2022 is added to the Bluetooth signal from the blocks 2016 or 2032 to cancel the interfering 802/11b/g signal.

In one embodiment, the output of the 2022 is input to two functions of the blocks 2023 and 2024. The block 2023 receives a copy of the cancellation signal from the block 2022 that was used to cancel the interference. In the block 2023, a complex correlator computes the cross correlation between the output of the block 2024 and the cancellation signal from the block 2022. As described above, the complex correlator is a function that computes the cross correlation between two signal in phase and amplitude. The 90 degree phase shifted signal of one signal is cross correlated with the other signal to get the phase correlation and the non-phase shifted version is cross correlated to get the amplitude correlation. The block 2023 sends amplitude and phase control signals to the block 2022 to adjust the phase and amplitude of the cancellation signal so as to drive the cross correlation to a minimum. If the cancellation has been done perfectly, the cross correlation will be zero. There may always be a small residual cross correlation as the algorithm will “dither” around the optimal phase and amplitude adjustment. It should be noted that one of ordinary skill in the art would recognize that the residual error can be made very small as a function of required accuracy and implementation complexity.

In one embodiment, the Macro delay buffer 2021 provides delays which are an integral multiple of the samples. The micro delay, which provides for sub-sample phase shifts, uses a different technique as shown in FIG. 3. When operating in the digital sample space, it is possible to have an over sampled waveform from Nyquist sampling point of view, but only have a few samples per cycle of the carrier signal (or IF). If full sample delays are used (as in the macro delay buffer), only very large phase shifts are achievable, such as around 75 to 90 degrees. This may not be accurate enough to line up the cancellation signal with the interfering signal. For this reason, the sub-sample phase shift is required.

In one embodiment, as shown in FIG. 3, the initial samples are at the times A, B, and C. In one embodiment, intermediate values a, b, and c are computed by linear interpolation and the new values are time mapped into the time slots for A, B, and C. By using this technique, the sub-sample phase shifts can be made arbitrarily small.

In one embodiment, after the interference calculation is done in the block 2024, the digital samples are input to the block 2027. In the block 2027, the I and Q signals are separated by a down-sampling apparatus. The digital samples are taken in groups of four samples. The first and the third are averaged to get the I channel and the second and fourth are averaged to get the Q sample. The apparatus of digitally performing the cancellation on a composite signal and then performing the decomposition into the I and Q waveforms eliminates the problems involved with I-Q quadrature and amplitude balance. If I and Q is not required, a simple digital down-conversion is done.

In one embodiment, the BT signal is not decomposed into I and Q and is sent to the MAC baseband processor as a single digital base band signal.

In another embodiment, the digital samples from 2024 are multiplied by a digital sine and cosine at the required frequency to down-convert the signals to baseband. In another embodiment, the signal is not decomposed into I and Q but delivered to the MAC baseband processor as a composite signal.

Receiver: 802.11b/g with Interference Mitigation for the Cancellation of Extraneous Signals in the ISM Band such as other BT not on the PC and Cordless Phones and Microwave Ovens

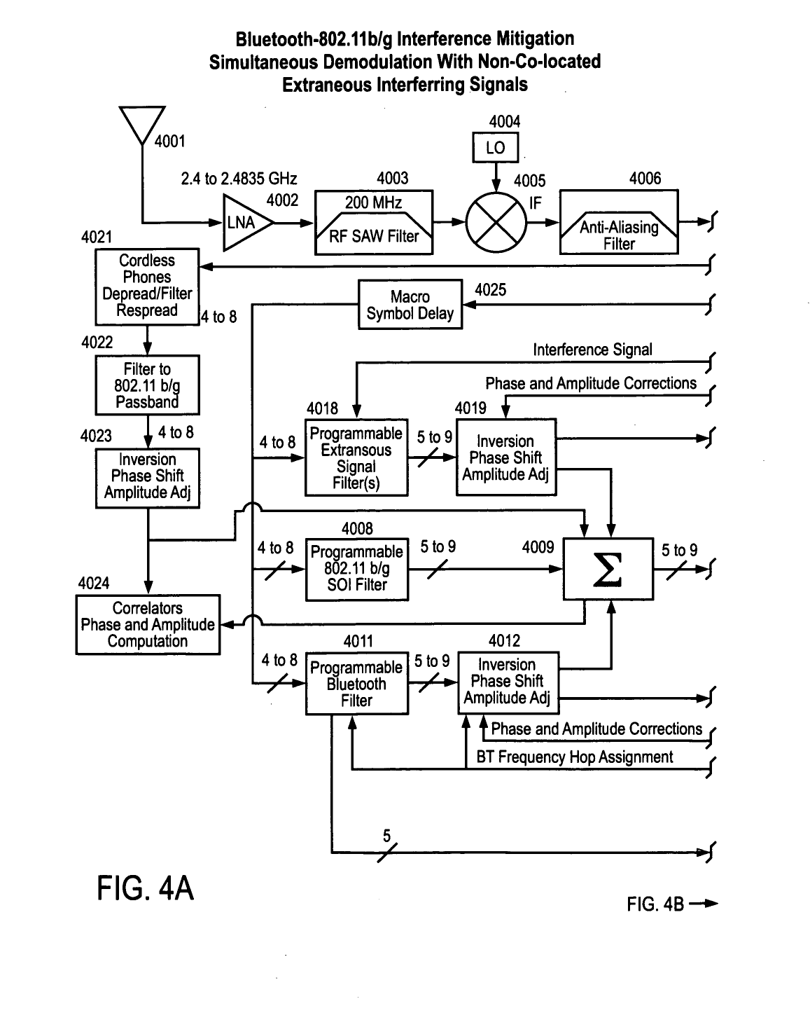

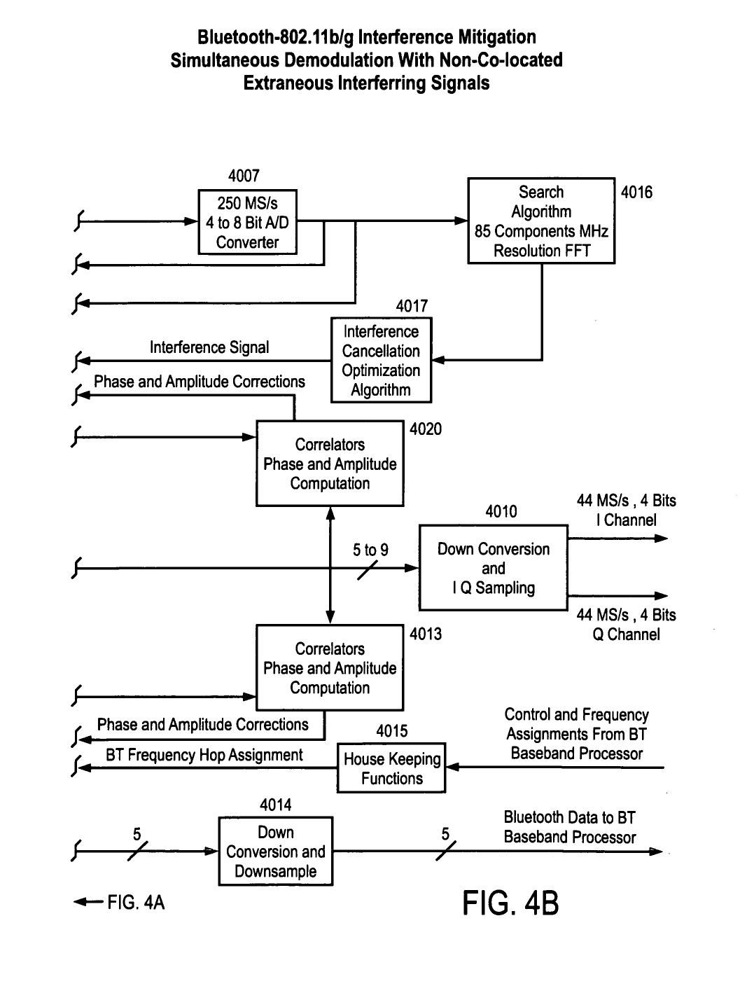

In one embodiment, the transmitted 802.11b/g and Bluetooth signals are not required. This embodiment uses that fact that the 802.11b/g signals are very wideband with respect to the Bluetooth signals and the Bluetooth hopping sequence in a known entity or can be quickly determined. This embodiment is shown in FIG. 4.

FIG. 4 illustrates an alternate embodiment of an apparatus that provides receiver interference mitigation when the interference is from third party interference and or extraneous interfering signal incident on the PC. In this embodiment, the Bluetooth signal is isolated and used for two purposes. It is used to process and support the Bluetooth functions and it is used to cancel the interference of the Bluetooth on the 802.11b/g. In this embodiment, the BT signals that do not originate from the PC can be taken out. Other extraneous signals that may be present such as cordless phones and microwave ovens can also be cancelled as will be discussed below.

Since the Bluetooth signal is only 1/20 the bandwidth of the 802.11b/g signal, filtering may provide a 20:1 improvement in the signal to noise ratio over the interfering 802.11b/g signal. The 802.11b signal is a spread spectrum signal and the energy of the interfering Bluetooth signal is concentrated in one MHz. The Bluetooth signal is frequency hopped over 79 frequencies and only overlaps with the 802.11b spectrum ¼ of the time. By using the recovered Bluetooth signal to cancel the interference in the 802.11b/g signal there may only be a loss of 0.2 dB in the 802.11b/g signal strength, and this only happens ¼ of the time. If the recovered BT signal is used to cancel the BT component in the WiFi, the signal loss of the WiFi is 1/20 or 0.2 dB.

In one embodiment, as shown in FIG. 4, the RF signal energy is received through the antenna 4001 and amplified in the Low Noise Amplifier (LNA) 4002. The signal is then down-converted to an IF by an image reject mixer and then filtered by an anti-aliasing filter. In one embodiment, the RF SAW filter 4003 provides the anti-aliasing filtering function prior to the A/D converter. The SAW filter 4003 and the anti-aliasing filter 4006 (if required) have, for example, a nominal bandwidth of 85 MHz for the ISM band. The A/D converter samples the entire ISM band with 4 to 8 bit samples at some rate above the Nyquist sampling rate. For this example, 250 Mega samples per second is used. Alternatively, other sampling rates may be selected.

In one embodiment, the A/D converter is flash A/D. In another embodiment, the A/D converter is an over sampling sigma delta A/D converter.

In one embodiment, the A/D conversion is done at an IF or low IF (where low IF is 2 to 3 times the baseband bandwidth of the signal bandwidth). In another embodiment, the A/D conversion is performed at the RF frequency of the ISM band without the down-conversion elements, namely LO 4004 and mixer 4005. It should be noted that one of ordinary skill in the art would recognize that the sampling rate can be varied as long as rate is high enough to preclude aliasing. Higher sample rates can have some advantages as well as disadvantages, but are an implementation details. For example, the lower IF, provides for a better SNR in the A/D converter and the SNR is limited as a function of the phase noise on the sampling clock and the highest frequency in the sampled frequency. Given the same phase noise on the sampling clock, the lower the IF, the better will be the SNR, and thus the effective number of bits. In one embodiment, an IF on the order of 200 to 600 MHz is used. Alternatively, the IP may be other frequencies.

In one embodiment, the output of the A/D converter is spit into up to five (5) signals and input to components 4008, 4011, 4018, 4021 and 4016.

The programmable 802.11b/g SOI filter 4008 contains the decimating filters for the recovery of the 802.11b/g. The programmable Bluetooth filter 4011 contains the frequency hopped 1 MHz decimating filters for the recovery of the BT signals which are being used by the 802.11b/g user. The programmable extraneous signal filter 4018 contains the programmable filters for recovery of extraneous interfering signals from all other sources to include “other” BT signals, such as, for example, microwave ovens, or the like. The extraneous interfering signals are any signals that are not generated by a user that interferes with that user. The block 4021 contains the search algorithm for the DSSS cordless phone signals. The block 4016 contains the search algorithm for determining the location of the extraneous interfering signals.

### Extraneous Interfering Signal Search Block 4016

In one embodiment, the search algorithm includes breaking the ISM pass band in to 85 frequency bins of 1 MHz width each. An 85 point FFT is computed and the energy in each “bin” is determined by the magnitude of the FFT component in that bin. The time required to compute an FFT is approximately inversely proportional to the frequency resolution of the FFT. In this case, the FFT resolution is 1 MHz, so the time required for each search is about 1 micro second. If the search is recomputed every 10 microseconds, the delay is canceling interfering signal is very small and the detection of the absence of an interfering signal is short. This allows the signals to be cancelled in a very short period of time and the cancellation to be stopped if the interfering signal is no longer present. In other embodiments, programmable notch filters or narrowband pass band filters may be used to acquire cancellation signals.

In the search algorithm, the frequency components of the FFT are calculated for each 1 MHz frequency “bin” and the average value is computed. Energy in bins above the average and exceeding a certain level are candidates for cancellation. The “certain” level is adjusted by an algorithm, which optimizes the interference mitigation. The block 4016 sends control signals to the programmable extraneous signal filter 4018 to set the parameters of the pass band filters, which isolate the interfering signals. These isolated interfering signals are then used to cancel the interference in the 802.11b/g signals. A sub process in the search algorithm may search for extraneous BT signals and determine the hopping frequency and then operate on these signals in the same way it does in the programmable Bluetooth filter 4011.

Interference Mitigation Optimization Algorithm

The Interference mitigation optimization algorithm controls the maximum bandwidth of the decimating filters in the programmable extraneous signal filter 4018 to control the degradation to the SOI. The SOI is the desired signal. The cancellation signal is used to cancel interference that is within the passband of the SOI. An absolute optimization cannot be guaranteed, but to simplify the descriptions, the term optimization and optimize are used to mean that the processes is moved in way as to approach an optimization of the interference mitigation or cancellation process. For 802.11b/g, the cancellation process may remove some of the signal of interest, but it looks like a frequency fade, and may remove significant interfering energy. The interference mitigation optimization algorithm determines the amount of energy that the cancellation process removes by controlling the bandwidth of the programmable decimating filters in the programmable extraneous signal filter 4018 and the “effective” frequency fading imposed on the signal of interest. Due to the nature of the DSSS 802.11b and the OFDM 802.11g, both signals can operate with significant frequency fading.

Recovering 802.11b/g

The block 4008 contains a decimating and down-sampling filter for the 802.11b/g signals. With an initial sampling rate of 250 MHz in the 4 to 8 bit A/D converter, the signal to quantizing noise may be improved by the ratio of the signal bandwidth to the quantizing noise bandwidth. The quantizing noise bandwidth is 125 MHz. This may result in about 5:1 or an improvement of about 7 dB in signal to noise ratio resulting in one more bit. The output of the programmable 802.11b/g filter 4008 is a 5 to 9 bit sample at the rate required for the 802.11b/g processing. Depending on the apparatus of I Q decomposition and down-conversion, the sample rate out of the programmable 802.11b/g filter 4008 may vary. For this example, 88 Mega samples per second at five bits are used. A greater number of bits may used for 802.11g because of the greater required dynamic range.

Recovering BT Signals

In one embodiment, the 8 bit per sample 250 MS/s is input to the programmable Bluetooth filter 4011 which contains a frequency hopped programmable digital filter to isolate the Bluetooth (BT) signals at each of the hopped frequencies. The output samples are output from the programmable Bluetooth filter 4011 at 5 to 8 bits and 88 Mega Samples per second to match that of the 802.11b/g signal. This will make the signal cancellation easier. In another embodiment, the output of the programmable Bluetooth filter 4011 is at a lower sample rate (as required for the BT processing) and the signal is up-sampled for the interference cancellation function.

In one embodiment, one output of the programmable Bluetooth filter 4011 is sent to block 4014 for BT for processing and output to the Bluetooth MAC baseband processor. In the block 4014, the BT signal is down-sampled and down-converted to a baseband signal. If an I-Q representation of the BT signal is required, the I-Q decomposition will be one as described above in this patent.

Cancellation of BT Interfering Signal on 802/11b/g

In one embodiment, the output of the programmable Bluetooth filter 4011 is input to block 4012 in preparation for the BT cancellation. It is possible that the filtered BT signal, which is now the interference cancellation signal, may differ in phase and or amplitude compared with the BT signal in the 802.11b/g signal that is output from the programmable 802.11b/g SOI filter 4008. The block 4012 provides the adjustment for the sub-sample phase and amplitude as previously discussed above and shown in FIG. 3. The cancellation signal is inverted and added to the 802.11b/g signal in block 4009 to cancel the BT interference in the 802.11b/g signal. At the output of the cancellation process, the signal is sampled and input to block 4013 which has also received a copy of the cancellation signal from 4012. The copy of the cancellation signal is cross correlated with the 802.11b/g signal after the cancellation process in the complex correlator, which computes the phase and amplitude cross correlation. The block 4013 then sends control signals to the block 4012 to adjust the phase and amplitude of the cancellation signal until the complex correlation has reach a minimum. The process in continuously updated to optimize the interference cancellation process.

Extraneous Interference Signal Mitigation

In one embodiment, the function at block 4017 selects the frequencies components to be isolated under control of the Interference Mitigation Optimization Algorithm. The filter parameters are then sent to the programmable extraneous signal filter 4018. The real time signals are received in the programmable extraneous signal filter 4018 from the A/D converter 4007 and are then filtered to isolate the extraneous interfering signals. The output of the programmable extraneous signal filter 4018 is input to the block 4019 where the phase and amplitude of the cancellation signals are adjusted under control of block 4020 to optimize the cancellation process. In the case of interfering signals from microwave ovens and other extraneous signals, it may not be desirable that all interference signal frequencies are cancelled in the interference mitigation process. With the option to search on 1 MHz bins, selected bins can be cancelled (or notch filtered) under control of the Interference Mitigation Optimization Algorithm. This algorithm determines the trade off cancellation of interfering energy versus the “induced frequency fading” to optimize the interference mitigation process.

In one embodiment, there are multiple copies of the blocks 4018 thru 4020 for processing multiple cancellation signals in parallel. Since the interfering and thus the cancellation signals are uncorrelated, they can all be added to the 802.11b/g in parallel and the cross correlations on the post cancellation process can be done in parallel.

In one embodiment, all of the techniques described above are implemented in parallel to cancel the interference in the ISM band signal of interest. Since the interfering signals are uncorrelated, the cancellation and cross correlation processes can be done in parallel simultaneously. An arbitrary number of interfering signals can be simultaneously cancelled as a function of the amount of circuitry implemented.

Interference Mitigation for Interference from DSSS ISM Cordless Phones

As shown in FIG. 4, the block 4021 receives a copy of the ISM pass band digitized signal from the A/D converter 4007 and performs a search for DSSS cordless phone signals. When these signals are found, the signals are de-spread, narrowband filtered to take out excess noise and are then re-spread to become the interference cancellation signals for canceling the interference in the signal of interest, 802.11b/g. The re-spread signal is filtered in block 4022 with the same band pass filter as is used in the programmable 802.11b/g SOI filter 4008 to recover the 802.11b/g signals. The filtered re-spread signal is then input to block 4023 where it is inverted and the phase and amplitude are adjusted under the control of 4024 to optimize the cancellation process. The output of 4023 is input to the cancellation block 4009 and to the complex correlator of the block 4024. The output of the cancellation process is input to the block 4024 where it is cross correlated with the cancellation signal from the block 4023. In one embodiment, a macro delay 4025 (delay in some number of full sampler periods) is inserted prior to the programmable extraneous signal filter 4018, the programmable 802.11b/g SOI filter 4008, and the programmable Bluetooth filter 4011 to adjust for the additional delay that will be experienced in blocks 4021 thru 4024. The block 4012 send control signals to block 4013 to adjust the phase and amplitude of the cancellation signal to optimize the cancellation process in block 4009. The sub-sample phase shifting is done as previously described and shown in FIG. 3.

Cellular Telephony and WiFi and BT Receiver with Interference Mitigation

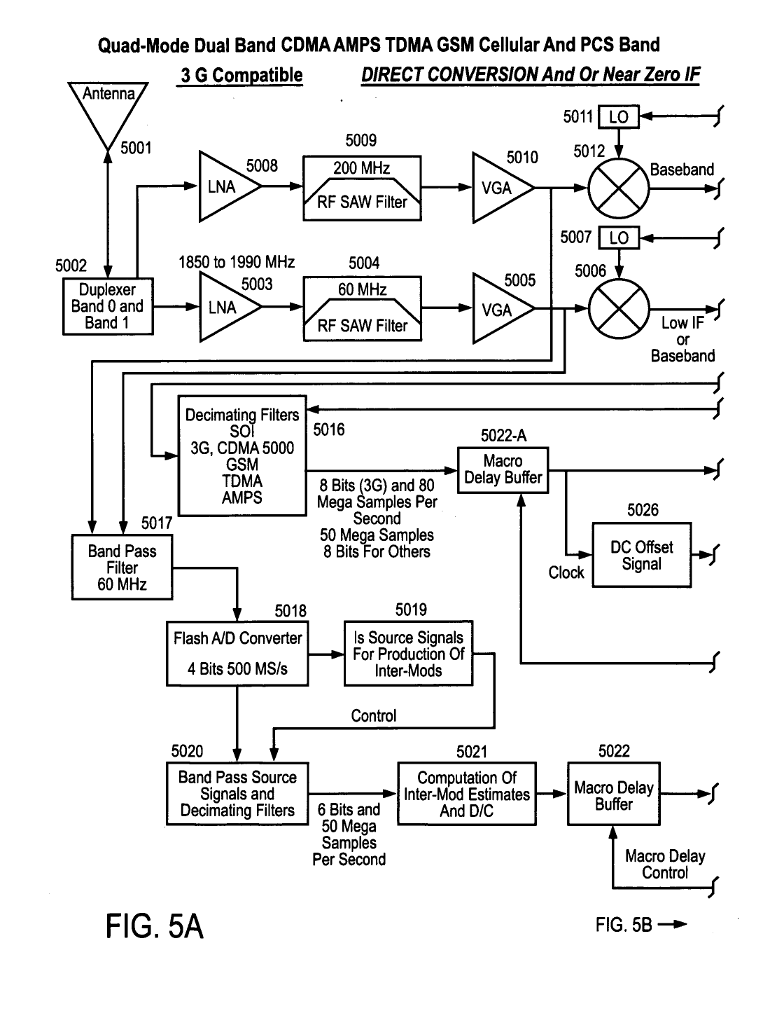

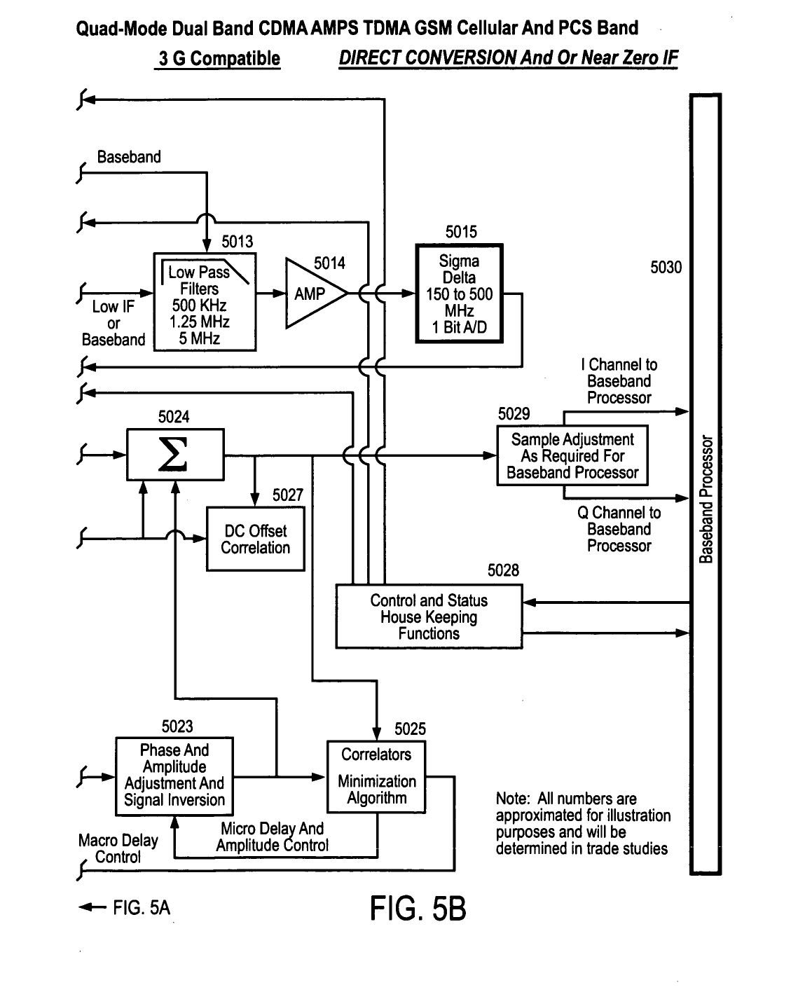

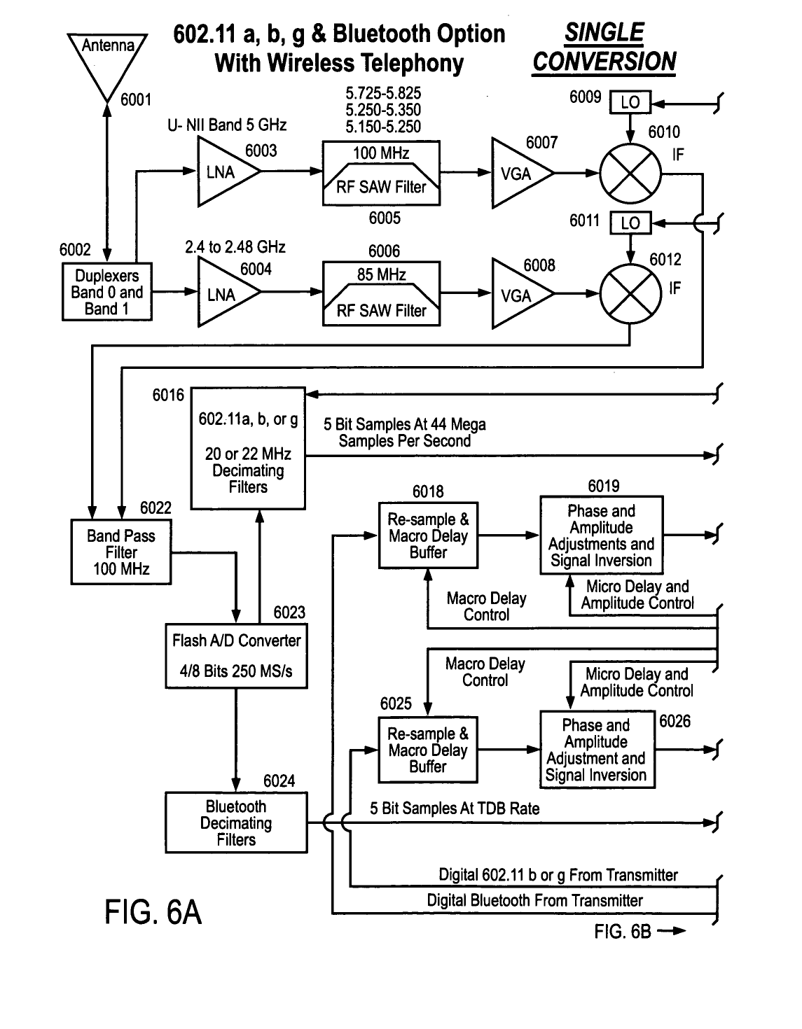

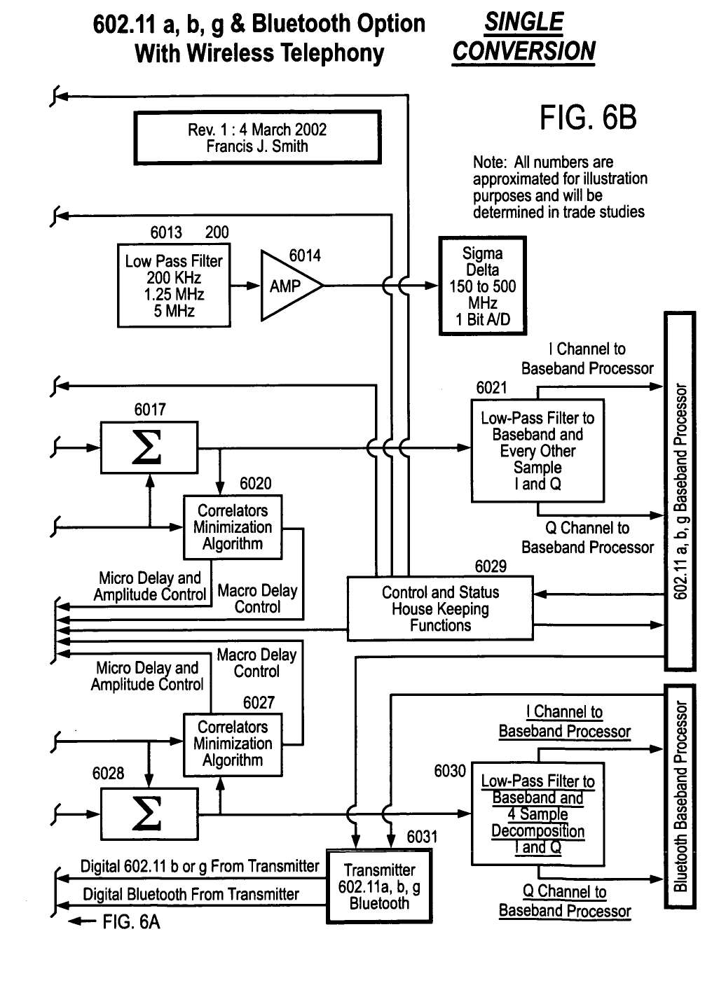

In one embodiment, the WiFi and BT capability is incorporated in the same receiver with cellular telephony. With this embodiment, a single physical layer receiver can support the wireless telephony and the WiFi and BT. In one embodiment, the telephony or the WiFi and BT are selected. In another embodiment, both are available simultaneously. When one or the other is selected, many common cells can be shared in the receiver and interference mitigation process. Simultaneous operation requires duplication of many cells. FIG. 5 shows the cellular telephony receiver with interference mitigation and FIG. 6 shows the configuration when the same receiver is used for WiFi and BT with interference mitigation. Note that in FIG. 6, only the mutual interference mitigation for WiFi and BT is shown to keep the drawing simple, but in one embodiment, the interference mitigation of extraneous signals and cordless phones is added as shown in FIGS. 2 and 4, and may be performed in parallel as discussed above.

FIG. 5 illustrates one embodiment of the top level architecture for the multi-mode telephony receiver with interference mitigation for CDMA 2000, AMPS, Time Division Multiple Access (TDMA), Global System for Mobile communications (GSM), General Packet Radio Service (GPRS), Enhanced Data rates for GSM Evolution (EDGE), Enhanced GPRS (EGPRS), Wideband Code Division Multiple Access (WCDMA). In the cellular telephony embodiment of FIG. 5, the receive band is nominally 50 or 60 MHz wide and the receiver front end (for the cellular band and the PCS band as an example) passed the entire receive band because the channel assignment is not known in advance. Blocks 5008 thru 5012 or blocks 5003 thru 5006 down-convert the full pass band to zero IF in one step. After the VGAs 5010 or 5005, the RF signal is split and one copy sent to 5012 or 5006 for direct down-conversion and the other is sent block 5017 or directly to 5018. If the SAW filters 5009 and 5004 provide sufficient filtering as to provide the anti-aliasing filtering, the band pass filter 5017 is not required. In block 5018, the entire receive pass band is sampled at a rate higher than Nyquist rate at a low resolution of 4 bits per sample. In one embodiment, the A/D converter 5018 has two resolutions, one for the telephony and higher resolution of 6 or 8 bits for the WiFi and BT functions. When lower resolution A/D function is being used, the other gates are powered down to save power. When sampling at RF, it is extremely difficult to get more than four effective bits of resolution and that is why the WiFi and BT signal is down-converted to IF prior to sampling so that 6 to 8 bits can be achieved to support the higher dynamic range of 802.11a and g. The lower resolution is adequate for the telephony because this path is only used for the interference mitigation function and not the recovery of the signal of interest.

Cellular Telephony

In one embodiment, the cellular telephony signal can experience significant interference from intermodulation products (IMPs) generated by high power signals in the receiver pass band. The IMP are interference signals generated by multiple signals present in a non-linear element. As shown in FIG. 5 the sampled pass band digital signal is sent to two blocks, 5020 and 5019 from the A/D converter 5018. The block 5020 is the real time path for the signals and provides the narrowband filters that isolate the high power signals that are the source of the IMPs that are interference to the signal of interest. In block 5019, a fast search algorithm finds the location of the high power signals and sends a control signal to the block 5020 where the programmable digital filters isolate the source signals that generate the IMPs. The isolated source signals are used in block 5021 to generate an estimate of the IMP. The output of the block 5021 in input to the macro delay buffer 5022 where the macro phase adjustment is done by delaying some number of whole sample periods under the control of block 5025 which computes the cross correlation between the SOI after cancellation and the cancellation signal to minimize the cross correlation and optimize the cancellation process. Block 5023 performs the amplitude adjustment and micro phase adjustment to the IMP cancellation signal as shown in FIG. 3.

In one embodiment, the analog receive signal is down-converted to zero IF in blocks 5012 or 5006 and then filtered in the block 5013. The output of the low pass filters of block 5013 is amplified by the amplifier 5014 to set the correct level into the sigma delta sampler 5015. The down-conversion in blocks 5012 and 5006 and the subsequent processing in blocks 5013 thru 5016 and 2022-A, 5025 thru 5017 and 5029 are done for both I and Q. However, the down-conversion has not been illustrated for ease of illustration. The sigma delta sampler followed by the decimating filters in block 5016 provides 14 bits of resolution, which is required to support the instantaneous dynamic range requirements of cellular telephony. The decimating filters in the block 5016 are selectable, one for each telephony standard, CDMA 2000, AMPS, TDMA, GSM, GPRS, EDGE, WCDMA, or the like.

In one embodiment, the block 5022-A provides a macro delay function at full sample times if the SOI is ahead of the cancellation signal is phase. The output of 5022-A is input to the IMP cancellation block 5024 where in the IMP cancellation signal from block 5023 is used to cancel the interference in-band of the SOI. At the output of the cancellation block, the signal is sampled and input to the complex correlator block 5025 where in the cancellation signal is cross correlated with the SOI after the cancellation process. If the cancellation process is perfect the complex cross correlation will be zero or near zero. The block 5025 sends control signals to blocks 5022 and 5023 to adjust the phase and amplitude of the IMP cancellation signal to minimize the complex cross correlation and to move the cancellation process toward an optimum.

In one embodiment, the DC offset problem in direct conversion receivers is also handled in a similar manner to that of the IMP interference. At the output of block 5022-A, the sampling clock is used in the block 5026 to generate a DC digital sample and this signal is inverted and input to the cancellation cell and the DC offset correlation block 5027. Not shown in FIG. 5 is a control signal that goes from 5027 to 5013, where the active analog filters have a DC offset adjustment feature to remove some of the DC offset prior to the sigma delta sampler to preclude saturation of analog components at zero IF. Residual DC offset is also removed via the cancellation process of blocks 5024, 5026, and 5027 in a similar manner to blocks 5022, 5023, 5024 and 5025. The DC offset and the IMP cancellation can be done simultaneously because the interfering signals are uncorrelated.

WiFi & BT and Cellular Telephony

In one embodiment, the receiver supports WiFi and BT or Cellular Telephony as shown in FIG. 6. FIG. 6 illustrates one embodiment of a subset of FIG. 5 which provides an architecture where cells used for wireless telephony are reused for WiFi and BT to provide a highly integrated Cellular and W-Fi/BT capable phone which can switch between modes, such as cellular telephone to voice over IP (VoIP) on WiFi within the same physic layer chip (i.e., integrated circuit). In FIG. 5 and FIG. 6, blocks 5018 and 6023 are the same block. The mixers 5012 and 5007 are the same as the mixers 6010 and 6012. The mixing signals and at the input to the mixers are not at the RF of the 802.11a or the 802.11b/g and BT, but rather at a frequency that will down-convert the signals to a convenient IF of around 500 or 600 MHz. It should be noted that one of ordinary skill in the art would realize that the selection of the particular IF is a design implementation detail and does not impact the general application of the invention, provided the IF is low enough to allow for sufficient SNR in the sampling process and high enough to preclude aliasing. The A/D converter 5018/6023 has two modes, one at four bits and one at six to eight bits. When used in the telephony mode and sampling at RF, only four effective bits are practical, so the circuits for the other fours bits can be turned off. In the WiFi & BT mode, the lower IF supports more effective bits than four. After the A/D converter, the sampled signal is sent to the WiFi and BT decimating filters and the interference cancellation is the same as that described for FIGS. 2, 3 and 4.

### Non-Linear Transmitter

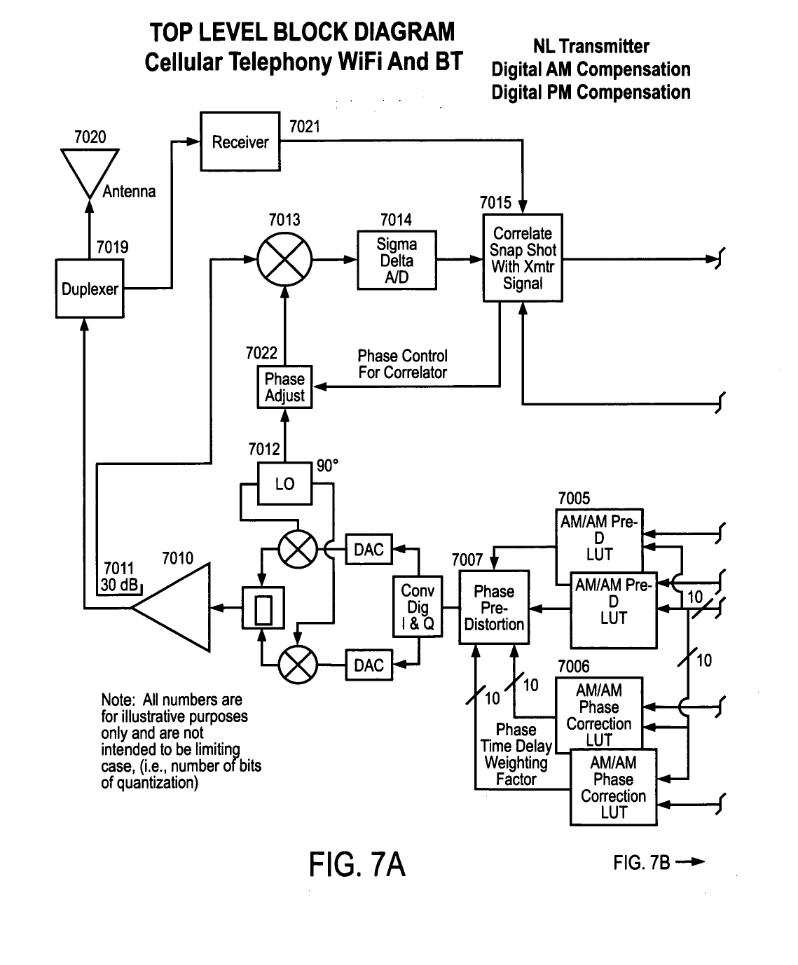

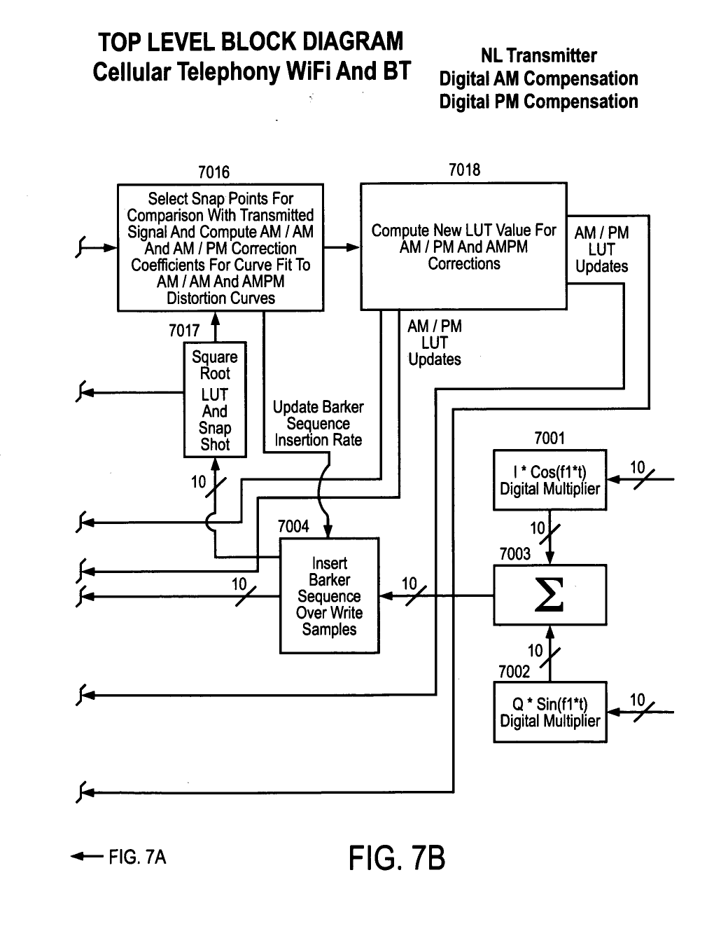

FIG. 7 illustrates one embodiment of the non-linear transmitter that provides the capability to operate high power transmission amplifiers in the non-linear range where the PAE is greatest. The non-linear operation supports multi-amplitude signals. 802.11a and 802.11g are OFDM and use modulations up to 64QAM. High order modulation results in peak to average power ratios of 10 to 15 dB. With linear amplifiers, a back off of 20 dB or more may be required due to the AM/AM and AM/PM of the amplifiers. If the signal is pre-distorted to induce the opposite AM/AM and AM/PM to that induced by the amplifier chain, the amplifiers can be operated in the nonlinear region. The PAE is much greater in the non-linear region of the amplifier operating range. Non-linear pre-distortion has been done in numerous conventional application, however, the embodiments described herein perform the function in such a manner that the power and size requirements make implementation of non-linear pre-distortion practical for handsets.

In one embodiment, the digital signals to be transmitted are received from the base band processor in the form of I and Q digital samples. The technique used in this invention is to convert the digital I and Q samples to a digital low IF composite signal and then perform the AM/AM and AM/PM pre-distortion on the composite signal. After the AM/AM and AM/PM pre-distortion is done, the pre-distorted signal is converted back to digital zero IF I and Q, and these signals are converted to analog signal in the DACs, and are used to modulate the quadrature sine and cosine for the composite transmit signal. The output of the amplifier chain is sampled and used to update the pre-distortion algorithm to compensate for changes in the non-linear characteristics in the amplifier chain over time and temperature. This architecture which converts the signal to a low IF and then pre-distorts the composite signal saves significant power and real estate in the receiver. The pre-distortion may done in the digital domain where it is easy to control.

### Combined Multi-Band Multi-Mode Cellular Telephony and WiFi and Bluetooth Transceiver Architecture

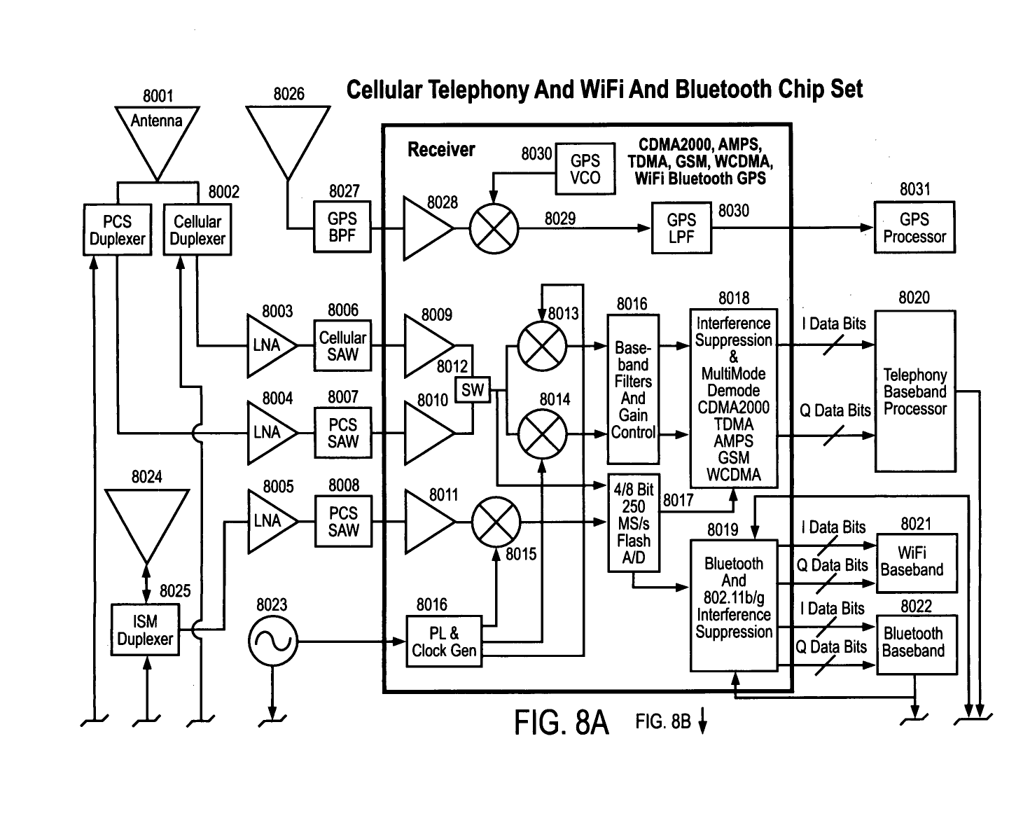

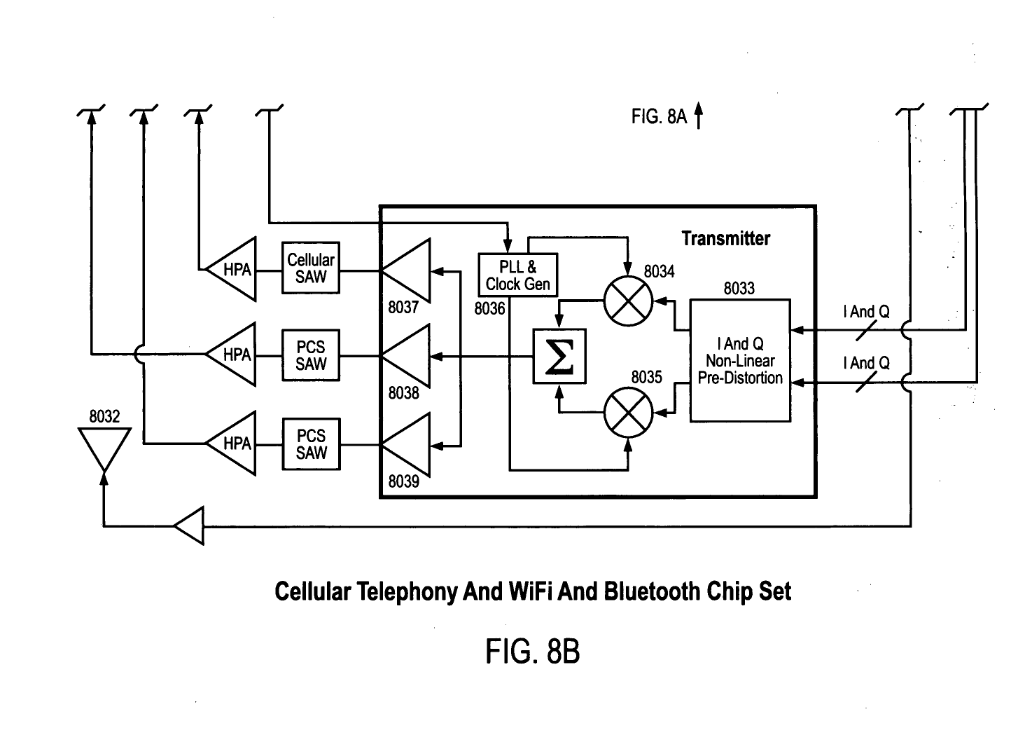

FIG. 8 illustrates a top level of one embodiment of the transmitter and receiver architecture for a WiFi BT and wireless Telephony where any of the wireless standards, such as, for example, CDMA 2000, AMPS, TDMA, GSM, GPRS, EDGE, WCDMA, 802.11a/b/g or BT can be selected and interference mitigation is provided. FIG. 8 shows the combined architecture for a Multi-band, Multi-mode Cellular Telephony and WiFi and Bluetooth Transceiver Chip Set. This architecture incorporates all of the wireless standards into a single architecture for devices that require roaming around the world and the capability to switch between cellular telephony for voice and or data to a WAN for data and VoIP. This architecture provides the physical layer to support all of the wireless standards with interference mitigation and a non-linear transmitter.

Embodiments of the present invention, described herein, include various operations. These operations may be performed by hardware components, software, firmware, or a combination thereof. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory or another type of medium suitable for storing electronic instructions. The machine-readable transmission medium may include, but is not limited to, electrical, optical, acoustical, or other form of propagated signal (e.g., carrier waves, infrared signals, digital signals, or the like) or another type of medium suitable for transmitting electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method comprising:
over-sampling of a pass band of signal of interests;
filtering the sampled signal with different decimating band pass filters to recover different signals of interest as interference cancellation signals, wherein the different signals of interest overlap in frequency at least in part with each other; and
removing a narrow band high power interfering signal from wideband, lower-powered signals using the interference cancellation signals.

2. A method, comprising:
receiving transmitted signals from a given platform;
generating copies of the transmitted signals from the given platform as interference cancellation signals; and
canceling interference on the received signals in the same radio frequency (RF) spectrum on the given platform using the interference cancellation signals.

3. The method of claim 2, wherein at least one of the transmitted signals is a narrow band, high-power interfering signal that interferes with received signals in a wideband, lower-powered signals, wherein said generating the copies of the transmitted signals comprises locating interfering energy of an in-band interfering signal within a frequency band of interest of the wideband, lower-powered signal to isolate a copy of an interfering signal among the received signals, and wherein said canceling the interference comprises canceling the in-band interfering signal within the frequency band of interest using the isolated copy of the interfering signal.

4. The method of claim 3, wherein said locating the interfering energy comprises:
searching the frequency band of interest to locate transmitted signals that exceed an average power within narrowband slices of the RF spectrum;
isolating the transmitted signals that exceed the average power as high power signals;
generating interference cancellation signals based on the isolated transmitted signals; and
canceling the interference using the interference cancellation signals within the frequency band of interest.

5. The method of claim 4, further comprising varying a passband on the interference cancellation signals such as to approach an optimization between induced frequency fading and interference energy cancellation.

6. The method of claim 2, further comprising performing a cross correlation between the received signals after canceling the interference and the interference cancellation signal to provide control signals to optimize said canceling the interference process.

7. A method, comprising:
simultaneously recovering two or more signals from a single receive signal path wherein the signals occupy the same frequency band which induces mutual interference;
generating a copy of one of the recovered two or more signals as an interference cancellation signal; and
performing cancellation of the mutual interference in a signal of interest using the interference cancellation signal.

8. The method of claim 7, further comprising:
searching for a DSSS interfering signal; and
recovering an interfering signal based on the search, wherein the interfering signal is to be used as the interference cancellation signal.

9. The method of claim 7, wherein said recovering comprises:
dispreading the DSSS interfering signal;
narrowband filtering the DSSS interfering signal to reject noise;
re-spreading the filtered DSSS interfering signal, wherein the re-spreading signal is used as the interference cancellation signal to mitigate interference in the signal of interest.

10. The method of claim 7, wherein the two or more signals comprise Bluetooth and WiFi signals, and wherein the Bluetooth and WiFi signals occupy the same frequency band which induces mutual interference, wherein the same frequency band is the Industrial, Scientific, and Medical (ISM) band, wherein the Bluetooth and WiFi signals are simultaneously recovered, and wherein the method further comprises:
generating copies of the Bluetooth and WiFi signals; and
performing cancellation of the mutual interference between the Bluetooth and WiFi signals using the generated copies to cancel interference caused by the presence of transmitters and receivers for both signals on the same platform.

11. The method of claim 7, wherein the two or more signals comprise Bluetooth and WiFi signals, wherein the Bluetooth signal is not on the same platform as the WiFi signal, wherein the Bluetooth and WiFi signals occupy the same frequency band which induces mutual interference, and wherein the method further comprises:
locating the Bluetooth signal among the two or more signals; and
isolating a copy of the interfering signal using a programmable filter.

12. The method of claim 11, wherein said locating the Bluetooth signal comprises:
determining a sequence of hopping frequencies by successive searches; and
storing the determined sequence.

13. The method of claim 12, further comprising storing a phase and amplitude offsets for the interference cancellation signals to expedite said performing cancellation of the mutual interference.

14. The method of claim 13, further comprising updating the phase and amplitude offsets for each frequency hop of the Bluetooth signal.

15. The method of claim 14, wherein said updating occurs 1600 times per second when hopping over seventy-nine frequencies.

16. The method of claim 7, wherein said generating the copy comprises isolating an extraneous interfering signal in the same frequency band from the two or more signals using an fast Fourier transform (FFT) that determines when the energy in any 1 MHz pass band exceeds an average signal power level, wherein the isolated extraneous interfering signal is the interference cancellation signal.

17. The method of claim 7, wherein said isolating comprises isolating the extraneous interfering signal using a programmable filter, and wherein the programmable filter has a selectable energy level to set the average signal power level.

18. The method of claim 16, further comprising:
dividing a receive passband of the signal of interest into a number of frequency bins; and
computing a fast Fourier transform (FFT) to locate a general location of the extraneous interfering signal that has a high power relative to the average signal power level.

19. The method of claim 13, further comprising adjusting the phase of the interference cancellation signal to optimize said cancelling the interference.

20. The method of claim 19, wherein said adjusting comprises either:
adjusting the phase of the interference cancellation signal via a macro phase adjustment, wherein the macro phase adjustment is done at full sample time increments; or
adjusting the phase of the interference cancellation signal via a micro phase adjustment, wherein the micro phase adjustment is done on a sub-sample increment by interpolation between samples and a re-mapping of the new samples into the old sample time slots.

21. The method of claim 20, further comprising cross correlating the interference cancellation signal with the signal of interest after said cancelling the interference to provide a control signal for the macro or micro phase adjustments.

22. The method of claim 21, wherein the phase and amplitude of the interference cancellation signal are adjusted to minimize the cross correlation which moves said cancelling the interference toward an optimum.

23. The method of claim 7, further comprising down-converting in frequency a receive passband of the signal of interest to an intermediate frequency (IF) such that the receive passband can be sampled with a predetermined signal-to-noise ratio (SNR).

24. The method of claim 7, further comprising:
filtering a digital sampled passband to recover the signal of interest;
down-converting the signal of interest to zero intermediate frequency (IF); and
decomposing the signal of interest into I and Q components.

25. The method of claim 7, wherein said simultaneously recovering comprises simultaneously recovering 802.11b/g and Bluetooth signals as the two or more signals from the single receive path in the Industrial, Scientific, and Medical (ISM) band, and wherein said performing cancellation comprises removing the mutual interference between the 802.11b/g and Bluetooth.

26. A machine-readable storage medium that provides instructions that, if executed by a processor, cause said processor to perform operations comprising:
over-sampling of a pass band of signal of interests;
filtering the sampled signal with different decimating band pass filters to recover different signals of interest as interference cancellation signals, wherein the different signals of interest overlap in frequency at least in part with each other; and
removing a narrow band high power interfering signal from wideband, lower-powered signals using the interference cancellation signals.

27. A machine-readable storage medium that provides instructions that, if executed by a processor, cause said processor to perform operations comprising:
receiving transmitted signals from a given platform;
generating copies of the transmitted signals from the given platform as interference cancellation signals; and
canceling interference on the received signals in the same radio frequency (RF) spectrum on the given platform using the interference cancellation signals.

28. A machine-readable storage medium that provides instructions that, if executed by a processor, cause said processor to perform operations comprising:
simultaneously recovering two or more signals from a single receive signal path wherein the signals occupy the same frequency band which induces mutual interference;
generating a copy of one of the recovered two or more signals as an interference cancellation signal; and
performing cancellation of the mutual interference in a signal of interest using the interference cancellation signal.
